(19) United States
(12) Patent Application Publication
(10) Pub. No.: US 2011/0255959 A1
(43) Pub. Date: Oct. 20, 2011

(54) TURBINE ALIGNMENT CONTROL SYSTEM AND METHOD

(75) Inventor: Brett Darrick Klingler, Greenville, SC (US)

(73) Assignee: GENERAL ELECTRIC COMPANY, Schenectady, NY (US)

(21) Appl. No.: 12/760,804

(22) Filed: Apr. 15, 2010

(51) Int. Cl. F01D 25/26; B23P 11/00

(52) U.S. Cl. 415/182.1; 29/889.2

(57) ABSTRACT

A turbine that includes a rotor, an inner turbine shell, an outer turbine shell, and a sliding engagement between the inner turbine shell and the outer turbine shell. The inner turbine shell is a single piece construction that completely surrounds at least a portion of the rotor, and the outer turbine shell surrounds the inner turbine shell. A method for aligning turbine components that includes aligning a single-piece inner turbine shell substantially concentric with a rotor and surrounding the single-piece inner turbine shell with an outer turbine shell. The method further includes supporting the single-piece inner turbine shell with respect to the outer turbine shell using a bearing assembly between the single-piece inner turbine shell and the outer turbine shell.

### FEDERAL RESEARCH STATEMENT

This invention was made with Government support under contract number DE-FC26-05NT42643 awarded by the Department of Energy. The Government may have certain rights in the invention.

### FIELD OF THE INVENTION

The present invention relates generally to rotating machines, such as power generating turbines. In particular, the present invention describes and enables a system and method for controlling the clearance between rotating and stationary components in a turbine.

### BACKGROUND OF THE INVENTION

Turbines and other forms of commercial equipment frequently include rotating components inside or proximate to stationary components. For example, a typical gas turbine includes a compressor at the front, one or more combustors radially disposed about the middle, and a turbine at the rear. The compressor includes multiple stages of rotating blades and stationary vanes. Ambient air enters the compressor, and the rotating blades and stationary vanes progressively impart kinetic energy to the working fluid (air) to bring it to a highly energized state. The working fluid exits the compressor and flows to the combustors where it mixes with fuel and ignites to generate combustion gases having a high temperature and pressure. The combustion gases exit the combustors and flow through a casing to the turbine. The turbine typically includes alternating stages of rotating blades or buckets and fixed blades or nozzles. The rotating blades or buckets are attached to a rotor, and the fixed blades or nozzles are attached to the casing. As the combustion gases flow over the buckets, they expand to cause the buckets, and thus the rotor, to rotate to produce work. The clearance between rotating and stationary components in a turbine is an important design consideration that balances efficiency and performance on the one hand with manufacturing and maintenance costs on the other hand. For example, reducing the clearance between rotating and stationary components generally improves efficiency and clearance between rotating and stationary components generally improves efficiency and performance of the turbine by reducing the amount of combustion gases that bypass the turbine buckets. However, reduced clearances may also result in additional manufacturing costs to achieve the reduced clearances and increased maintenance costs attributed to increased rubbing, friction, or impact between the rotating and stationary components. The increased maintenance costs may be a particular concern in turbines in which the rotating components often rotate at speeds in excess of 1,000 revolutions per minute, may have a relatively large mass, and may include delicate aerodynamic surfaces.

Active and passive methods and systems that attempt to achieve a consistent clearance between rotating and stationary components are known in the art. For example, U.S. Pat. No. 6,126,390 describes a passive system in which airflow from the compressor or combustor is metered to the turbine casing to heat or cool the turbine casing, depending on the temperature of the incoming air. Conventional air-cooling systems, however, rely on uniform circumferential expansion of the rotor, turbine buckets, shrouds, and surrounding casings. These air-cooling systems often do not account for eccentricities between stationary and rotating components introduced through manufacturing or assembly tolerances or that may develop during operation of the turbine as a result of bearing oil lift, thermal growth of the bearing structures, vibrations, uneven thermal expansion of the turbine components, casing slippage, gravity sag, and so forth. Anticipated inherent and operational eccentricities between stationary and rotating components should preferably be considered in design tolerances, resulting in minimum design clearances that prevent rubbing between the rotating and stationary components. In addition, static adjustments in the relative position of the stationary and rotating components during assembly may be used to compensate for eccentricity conditions. Static adjustments, however, cannot always accurately account for the variations in eccentricities that develop during the operating life of the turbine.

Thus, an active alignment control system and method would be useful to adjust for eccentricities that develop between turbine components over a wide range of operating conditions.

### BRIEF DESCRIPTION OF THE INVENTION

Aspects and advantages of the invention are set forth below in the following description, or may be obvious from the description, or may be learned through practice of the invention.

One embodiment of the present invention is a turbine that includes a rotor, an inner turbine shell, an outer turbine shell, and a sliding engagement between the inner turbine shell and the outer turbine shell. The inner turbine shell is a single piece construction that completely surrounds at least a portion of the rotor, and the outer turbine shell surrounds the inner turbine shell.

Another embodiment of the present invention is a turbine that includes a rotor, an inner turbine shell completely surrounding at least a portion of the rotor, and an outer turbine shell surrounding the inner turbine shell. The inner turbine shell includes a first support surface, and the outer turbine shell includes a second support surface opposed to the first support surface. The turbine further includes a bearing assembly between the first support surface and the second support surface.

The present invention also includes a method for aligning turbine components. The method includes aligning a single-piece inner turbine shell substantially concentric with a rotor and surrounding the single-piece inner turbine shell with an outer turbine shell. The method further includes supporting the single-piece inner turbine shell with respect to the outer turbine shell using a bearing assembly between the single-piece inner turbine shell and the outer turbine shell.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a simplified partial cross-section of a turbine according to one embodiment of the present invention;

FIG. 2 is a simplified axial cross-section of the turbine shown in FIG. 1 taken along line A-A;

FIG. 3 is a close-up plan view of a bearing assembly according to one embodiment of the present invention; and

FIG. 4 is a close-up plan view of a bearing assembly according to an alternate embodiment of the present invention.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

Embodiments of the present invention include a clearance control system that adjusts the position of an inner turbine shell with respect to a rotor and/or an outer turbine shell. In doing so, the system addresses several key parameters to reduce operating clearances between rotating and stationary components in the turbine to improve performance in a cost-effective manner. The key parameters include friction, eccentricity, out of roundness, muscle, cost, and ease-of-use. The system may further include clearance control structures and methods to control the temperature, and thus the expansion and contraction, of the inner turbine shell. Although various embodiments of the present invention may be described and illustrated in the context of a turbine, one of ordinary skill in the art will understand that the principles and teachings of the present application apply equally to type of turbine having rotating and stationary components in close proximity.

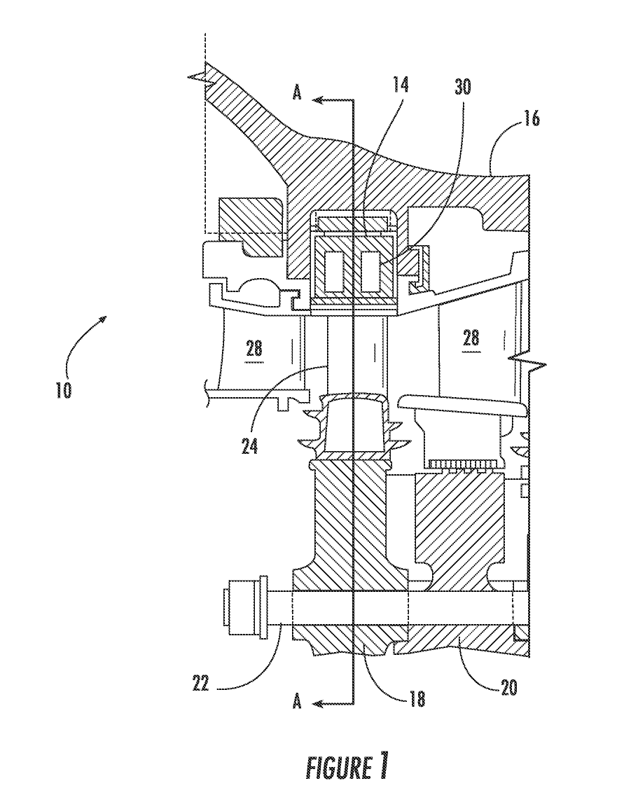

FIG. 1 provides a simplified partial cross-section of a turbine 10 according to one embodiment of the present invention. As shown, the turbine 10 generally includes a rotor 12, one or more inner turbine shells 14, and an outer turbine shell 16. The rotor 12 includes a plurality of turbine wheels 18 separated by spacers 20 along the length of the rotor 12. A bolt 22 extends through the turbine wheels 18 and spacers 20 to hold them in place and collectively form a portion of the rotor 12. Circumferentially spaced turbine buckets 24 connect to and extend radially outward from each turbine wheel 18 to form a stage in the turbine 10. For example, the turbine 10 shown in FIG. 1 includes three stages of turbine buckets 24, although the present invention is not limited according to the number of stages included in the turbine 10.

The inner turbine shells 14 completely surround at least a portion of the rotor 12. As shown in FIG. 1, for example, a separate inner turbine shell 14 completely surrounds the outer perimeter of each stage of turbine buckets 24. In this manner, the inner turbine shells 14 and the outer periphery of the turbine buckets 24 reduce the flow of hot gases that bypass a turbine stage. As shown in FIG. 1, the outer periphery of the turbine buckets 24 may further include a shroud extension 26 to reduce the clearance between the outer periphery of the turbine buckets 24 and the associated inner turbine shell 14, thereby further reducing the amount of hot gases that bypass a particular turbine stage. The outer turbine shell 16 generally surrounds the rotor 12 and the inner turbine shell 14. Circumferentially spaced nozzles 28 connect to the outer turbine shell 16 and extend radially inward toward the spacers 20. For example, as shown in FIG. 1, the first stage nozzle 28 at the far left connects to the outer turbine shell 16 so that the flow of the gases over the first stage nozzle 28 exerts a pressure against the outer turbine shell 16 in the downstream direction.

As shown in FIG. 1, the inner turbine shell 14 may include one or more internal passages 30. These passages 30 allow for the flow of a medium to heat or cool the inner turbine shell 14, as desired. For example, airflow from a compressor or combustor may be diverted from the hot gas path and metered through the passages 30 in the inner turbine shell 14. In this manner, the inner turbine shell 14 may be heated or cooled to allow it to expand or contract radially in a controlled manner to achieve a designed clearance 32 between the inner turbine shell 14 and the outer periphery of the turbine buckets 24. For example, during turbine 10 startup, heated air may be circulated through the various passages 30 of the inner turbine shell 14 to radially expand the inner turbine shell 14 outwardly from the outer periphery of the turbine buckets 24. Since the inner turbine shell 14 heats up faster than the rotor 12, this ensures adequate clearance between the inner turbine shell 14 and the outer periphery of the turbine buckets 24 during startup. During steady-state operations, the temperature of the air supplied to the inner turbine shell 14 may be adjusted to contract or expand the inner turbine shell 14 relative to the outer periphery of the turbine buckets 24, thereby producing the desired clearance between the inner turbine shell 14 and the outer periphery of the turbine buckets 24 to enhance the efficiency of the turbine 10 operation. Similarly, during turbine 10 shutdown, the temperature of the air supplied to the inner turbine shell 14 may be adjusted to ensure the inner turbine shell 14 contracts slower than the turbine buckets 24 to avoid excessive contact between the outer periphery of the turbine buckets 24 and the inner turbine shell 14. To that end, the temperature of the medium may be adjusted to maintain a desired clearance during shutdown.

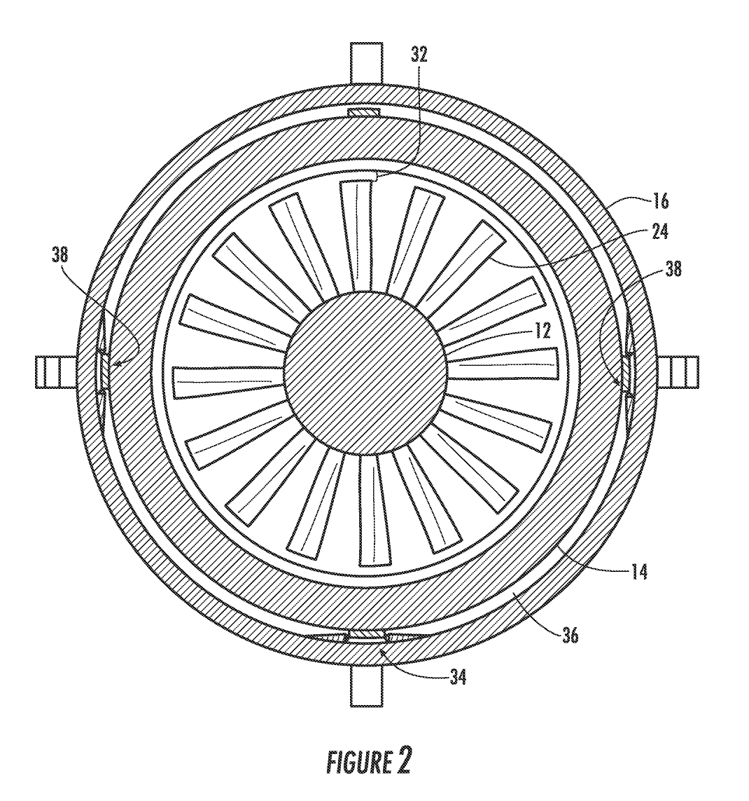

FIG. 2 shows a simplified axial cross-section of the turbine 10 shown in FIG. 1 taken along line A-A. In this view, the rotor 12 is in the center with the turbine buckets 24 extending radially therefrom. The inner turbine shell 14 completely surrounds the turbine buckets 24 and at least a portion of the rotor 12, providing the design clearance 32 between the inner turbine shell 14 and the outer periphery of the turbine buckets 24. In this particular embodiment, the inner turbine shell 14 comprises a single-piece construction that completely surrounds a portion of the rotor 12. The single-piece design minimizes eccentricities and out of roundness that more commonly occur in multi-piece designs. For example, in multi-piece designs, the bolted halves of the inner turbine shell 14 may create a disconnect across the bolted joints, potentially resulting in eccentricities and out of roundness due to thermal gradients during operation. Alternate embodiments within the scope of the present invention may include an inner turbine shell 14 comprising multiple pieces that completely surround a portion of the rotor 12. A gib block, key, or other detent 34 between the bottom of the inner turbine shell 14 and the bottom of the outer turbine shell 16 may be used to fix the inner turbine shell 14 laterally in place and restrict the inner turbine shell 14 from rotational movement with respect to the rotor 12 and/or the outer turbine shell 16.

As shown in FIG. 2, a gap 36 or space exists between the inner turbine shell 14 and the outer turbine shell 16. As a result, the inner turbine shell 14 is physically isolated from the outer turbine shell 16, preventing any distortion, contraction, or expansion of the outer turbine shell 16 from being transmitted to the inner turbine shell 14. For example, eccentricities or out of roundness created by thermal gradients of the hot gas path in the outer turbine shell 16 will not be transmitted to the inner turbine shell 14 and will therefore not affect the design clearance 32 between the inner turbine shell 14 and the outer periphery of the turbine buckets 24.

A bearing assembly 38 provides a sliding engagement between the inner turbine shell 14 and the outer turbine shell 16. In the case of an inner turbine shell 14 comprising a single-piece construction, the bearing assembly 38 may be located between the inner turbine shell 14 and the outer turbine shell 16 on opposite sides at approximately the vertical midpoint (i.e., approximately half of the distance between the top and bottom of the inner turbine shell 14) of the inner turbine shell 14. In alternate embodiments having multi-piece inner turbine shells 14, the system may include multiple bearing assemblies 38 evenly spaced around the periphery of the inner turbine shell 14.

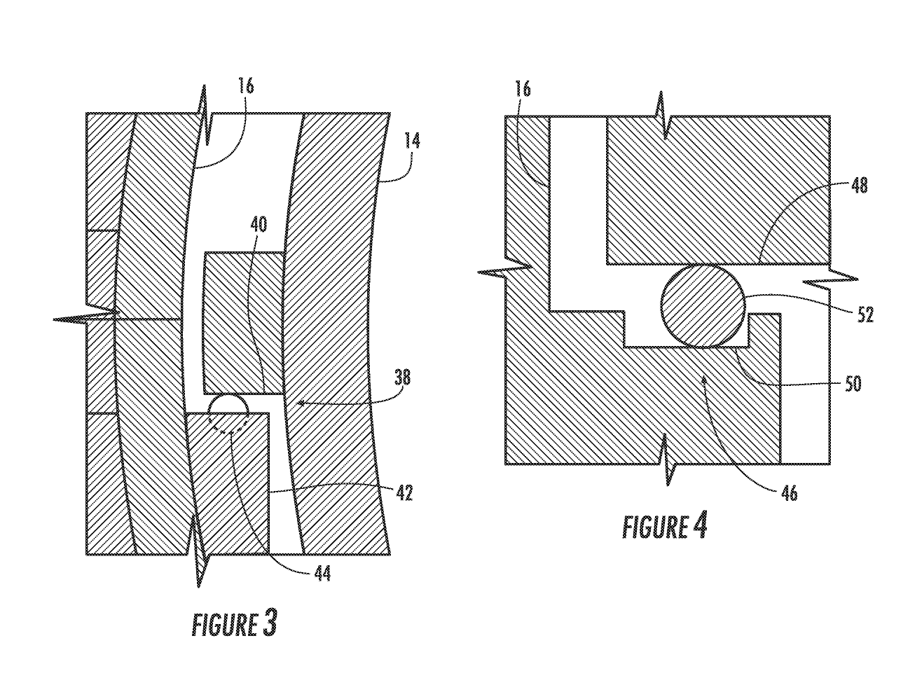

The bearing assembly 38 may include any structure known in the art for reducing friction between laterally moving structures. For example, as shown in FIG. 3, the bearing assembly 38 may include a first bearing support 40 attached to the outer periphery of the inner turbine shell 14 and a second bearing support 42 opposed to the first bearing support 40 and attached to the inner periphery of the outer turbine shell 16. The bearing assembly 38 may further include a journal bearing 44 or similar device between the first and second bearing supports 40, 42 to allow the inner turbine shell 14 to freely slide respect to the outer turbine shell 16. In this manner, the outer turbine shell 16 axially supports the inner turbine shell 14 through the bearing assembly 38, and the bearing assembly 38 substantially reduces friction between the inner turbine shell 14 and the outer turbine shell 16 during expansion and contraction. In addition, the designed clearance 32 between the inner turbine shell 14 and the outer periphery of the turbine buckets 24 may be reduced without a corresponding increase in the manufacturing costs to achieve such a tighter clearance.

FIG. 4 shows a close-up plan view of a bearing assembly 46 according to an alternate embodiment of the present invention. As shown, the bearing assembly 46 again includes first and second bearing supports 48, 50 opposing one another and between the inner turbine shell 14 and the outer turbine shell 16. In this embodiment, one or more balls 52 or bearings between the first and second bearing supports 48, 50 reduces friction between the bearing supports 48, 50 and allows the inner turbine shell 14 to slide with respect to the outer turbine shell 16.

The structures described and illustrated with respect to FIGS. 1 through 4 may be used to provide a method for aligning turbine 10 components. As shown in FIG. 1, the method may include aligning a single-piece inner turbine shell 14 substantially concentric with a rotor 12. The single-piece inner turbine shell 14 may be surrounded by an outer turbine shell 16. The method may further include supporting the single-piece inner turbine shell 14 with respect to the outer turbine shell 16, for example, such as by using the bearing assembly 38 between the single-piece inner turbine shell 14 and the outer turbine shell 16, as shown in FIG. 3 or 4. Referring to FIG. 1, the method may further include flowing a medium through passages 30 in the single-piece inner turbine shell 14 to radially expand or contract the single-piece inner turbine shell 14.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A turbine, comprising:
a. a rotor;
b. an inner turbine shell, wherein the inner turbine shell comprises a single piece construction that completely surrounds at least a portion of the rotor;
c. an outer turbine shell surrounding the inner turbine shell; and
d. a sliding engagement between the inner turbine shell and the outer turbine shell.

2. The turbine as in claim 1, wherein the sliding engagement comprises a first bearing support between the inner turbine shell and the outer turbine shell.

3. The turbine as in claim 2, wherein the sliding engagement comprises a second bearing support between the inner turbine shell and the outer turbine shell, wherein the second bearing support is located opposite the first bearing support.

4. The turbine as in claim 2, wherein the first bearing support comprises a journal bearing.

5. The turbine as in claim 2, wherein the first bearing support comprises a roller bearing.

6. The turbine as in claim 2, wherein the first bearing support is located at a vertical midpoint of the inner turbine shell.

7. The turbine as in claim 1, further including a detent between the inner turbine shell and the outer turbine shell.

8. The turbine as in claim 1, wherein the inner turbine shell defines an internal passage through which a medium flows to heat or cool the inner turbine shell.

9. A turbine, comprising:
a. a rotor;
b. an inner turbine shell completely surrounding at least a portion of the rotor, wherein the inner turbine shell includes a first support surface;
c. an outer turbine shell surrounding the inner turbine shell, wherein the outer turbine shell includes a second support surface opposed to the first support surface; and
d. a bearing between the first support surface and the second support surface.

10. The turbine as in claim 9, wherein the inner turbine shell comprises a single piece construction.

11. The turbine as in claim 9, wherein the first support surface is located at a vertical midpoint of the inner turbine shell.

12. The turbine as in claim 9, wherein the bearing comprises a journal bearing.

13. The turbine as in claim 9, wherein the bearing comprises a roller bearing.

14. The turbine as in claim 9, further including a detent between the inner turbine shell and the outer turbine shell.

15. The turbine as in claim 9, wherein the inner turbine shell defines an internal passage through which a medium flows to heat or cool the inner turbine shell.

16. A method for aligning turbine components comprising:
a. aligning a single-piece inner turbine shell substantially concentric with a rotor;
b. surrounding the single-piece inner turbine shell with an outer turbine shell; and
c. supporting the single-piece inner turbine shell with respect to the outer turbine shell using a bearing assembly between the single-piece inner turbine shell and the outer turbine shell.

17. The method as in claim 16, further including flowing a medium through passages in the single-piece inner turbine shell to radially expand or contract the single-piece inner turbine shell.

18. The method as in claim 16, further including supporting the inner turbine shell with respect to the outer turbine shell at a vertical midpoint of the inner turbine shell.
